(19) United States
(12) Patent Application Publication
(10) Pub. No.: US 2025/0359632 A1
(43) Pub. Date: Nov. 27, 2025

(54) MAGNETIC QUICK-RELEASE CLOSURE SYSTEM

(71) Applicant: NIKE, Inc., Beaverton, OR (US)

(72) Inventors: Joseph B. Gault, West Linn, OR (US); Andrew C. Lau, Happy Valley, OR (US); Jazzmin P. Martinez, Beaverton, OR (US); Austin J. Orand, Portland, OR (US); Jan Raken, Seattle, WA (US); Daniel Weeks, Portland, OR (US)

(73) Assignee: NIKE, Inc., Beaverton, OR (US)

(21) Appl. No.: 19/219,745

(22) Filed: May 27, 2025

Related U.S. Application Data
(60) Provisional application No. 63/651,940, filed on May 24, 2024.
(60) Provisional application No. 63/651,435, filed on May 24, 2024.

(51) Int. Cl. A43C 11/14; A44B 18/00

(52) U.S. Cl. CPC A43C 11/1406; A44B 18/0003; A44D 2203/00

(57) ABSTRACT

A magnetic quick-release closure system for apparel and footwear applications combines magnetic attraction with mechanical retention to provide secure closure with intuitive, single-handed release capability. The system includes a closure panel with first and second edges, and a receiving surface with complementary features. The first edge nests within an upstanding convex ledge on the receiving surface, creating a pivot point. Multiple magnet pairs draw the panel toward the receiving surface and assist alignment. A spring-biased retention latch engages the second edge of the closure panel when closed, providing mechanical security during athletic activities. A pull tab enables a translational pulling motion of the closure panel, aligning a notched portion on its second edge with the latch for quick release. The system may also incorporate magnetic repulsion assistance for opening and an over-center locking feature for enhanced security under tension.

### CROSS-REFERENCE TO RELATED APPLICATION

This application claims the benefit of priority to U.S. Provisional Application No. 63/651,940, filed May 24, 2024, and U.S. Provisional Application No. 63/651,435, filed May 24, 2024, both of which are incorporated by reference in their entirety.

### TECHNICAL FIELD

The present disclosure relates generally to closure systems for apparel and footwear, and more particularly to hybrid closure mechanisms that combine magnetic attraction with mechanical retention features for secure yet readily releasable attachment in wearable applications.

### BACKGROUND

Closure mechanisms constitute essential components in apparel, footwear, and accessories across athletic and lifestyle applications. Conventional closures employed in such applications—including buckles, clasps, snaps, hook-and-loop fasteners, and zippers—exhibit inherent limitations regarding operational ease, retention security, or durability under dynamic loading conditions.

Traditional mechanical closures typically require significant manual dexterity, visual confirmation, or two-handed operation for engagement or disengagement. Such operational requirements present difficulties for users during athletic activities where precise manipulation may be impaired by factors such as gloves, limited visibility, or when one hand is occupied. Additionally, purely mechanical closures commonly experience wear-related degradation following repeated use cycles, potentially resulting in diminished retention capability or security over time—a concern for performance applications.

Magnetic closures have been explored for certain applications to provide automatic alignment during engagement. However, simple magnetic closure systems typically provide insufficient retention force for applications involving the dynamic loading and applied tension experienced during athletic activities. When magnets of sufficient strength to resist such loads are employed, the resulting closure often becomes difficult to disengage, compromising operational convenience or negating convenience advantages.

In apparel and footwear applications where tension forces are applied across closure mechanisms—such as straps circumscribing body portions, equipment attachments, or garment closures—the technical challenges become particularly pronounced. The closure system must resist inadvertent opening under applied tension while simultaneously permitting deliberate release when desired by the user. Existing solutions, which may involve ratcheting mechanisms or friction-based systems, often prove cumbersome for single-handed operation, particularly when wearing gloves or during dynamic activities where operational reliability and ease of use are critical.

Accordingly, there exists a need in the art for a closure system specifically designed for apparel and footwear applications that provides secure retention under dynamic loading conditions while enabling intuitive, single-handed release operation with minimal dexterity requirements. Such a system would be valuable across athletic, performance, and technical apparel applications where operational reliability and ease of use are critical design considerations.

### SUMMARY

The present disclosure provides a magnetic quick-release closure system for apparel and footwear applications that combines magnetic attraction for component alignment and initial retention with mechanical features for enhanced security and secure locking, culminating in an intuitive release mechanism operable with minimal effort and single-handed operation. Unlike conventional closures utilized in garments and footwear that often require multiple operational steps or significant manual dexterity, the disclosed system enables rapid, one-handed operation while maintaining security against inadvertent opening during athletic activities and dynamic movement.

The magnetic quick-release closure system comprises a closure panel and a receiving surface, with strategically positioned magnet pairs configured to draw the closure panel toward the receiving surface and maintain positional alignment. Mechanical retention features, including a nesting edge configuration and a spring-biased retention latch, provide additional security beyond the capabilities of magnetic attraction alone. A user-activated release mechanism enables rapid disengagement through a translational pulling motion that simultaneously disengages the mechanical retention and, in certain embodiments, reconfigures the magnetic interaction from attraction to repulsion to assist the opening operation.

The system's design may create an over-center locking action when tension is applied, thereby increasing closure security as applied tension increases during activity, rather than compromising closure integrity. In apparel and footwear applications, the closure system may be integrated with elastic bands, straps, or other tension-bearing elements to create secure yet rapidly releasable attachments around body portions or between separate garment components.

The magnetic quick-release closure system may be constructed from various materials suitable for apparel and footwear applications, including polymers, composites, lightweight metals, or combinations thereof. The specific dimensions, retention force characteristics, and magnetic strength parameters may be tailored to particular use cases, from lightweight everyday apparel to high-performance athletic equipment requiring enhanced security and durability.

In one aspect, the invention provides a magnetic quick-release closure system comprising: a closure panel having a first edge, a second edge, and an upper edge extending between the first and second edges, wherein the second edge includes a notched portion; a receiving surface configured to receive the closure panel; a plurality of magnet pairs with first magnets located in the closure panel and second magnets located in the receiving surface, the magnet pairs being configured to draw the closure panel toward the receiving surface; a retention latch biased to extend from the receiving surface and configured to engage with the second edge of the closure panel when in a closed position; and a pull tab coupled to the closure panel configured, when pulled, to induce translational movement of the closure panel relative to the receiving surface to align the notched portion of the second edge with the retention latch, thereby allowing release of the closure panel.

In another aspect, the invention provides an article of footwear comprising a sole structure, an upper secured to the sole structure, and a magnetic quick-release closure system integrated with the article of footwear. The system includes a receiving surface integrated with a portion of the article of footwear, and a closure panel having the structural features described above, along with the magnet pairs, retention latch, and pull tab components configured to provide secure closure with intuitive single-handed release capability.

In a further aspect, the invention provides an article of apparel comprising a primary garment structure and a magnetic quick-release closure system integrated with the article of apparel. The system includes a receiving surface integrated with the primary garment structure, and a closure panel having the structural features described above, along with the magnet pairs, retention latch, and pull tab components.

### BRIEF DESCRIPTION OF THE DRAWINGS

The accompanying drawings, which are incorporated in and constitute a part of this specification, illustrate various embodiments of the magnetic quick-release closure system and, together with the detailed description, serve to explain the principles of the design.

FIG. 1 is a schematic exploded view of a magnetic quick-release closure system showing the basic structural components including the closure panel, receiving surface, and magnet arrangement.

FIG. 2 is a schematic side view of the magnetic quick-release closure system in a closed and locked state, showing the closure panel in flush contact with the receiving surface and the retention latch engaged.

FIG. 3 is a schematic side view of the magnetic quick-release closure system in an unlocked state during release operation, showing the translational movement of the closure panel and alignment of the notched portion with the retention latch.

FIG. 4 is a schematic view of the magnetic quick-release closure system in a partially assembled state, illustrating the pivoting motion of the closure panel around the nesting engagement between the first edge and convex ledge.

FIG. 5 is a perspective view of the magnetic quick-release closure system implemented in an athletic footwear application.

FIG. 6 is a schematic view of the magnetic quick-release closure system implemented in a performance apparel application.

FIG. 7 is a cross-sectional view illustrating the magnetic configuration in the closure system during normal closed operation, showing offset positioning of magnet pairs.

FIG. 8 is a cross-sectional view illustrating the magnetic configuration in the closure system during the release sequence, showing alignment of magnet pairs with opposite poles facing each other to create repulsive force.

### DETAILED DESCRIPTION

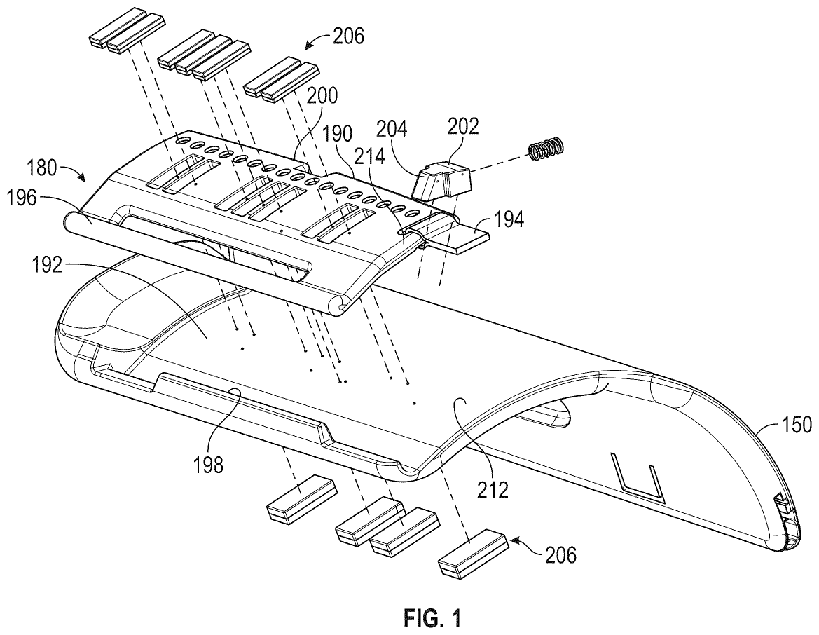

The present disclosure is directed to a magnetic quick-release closure system designed for secure attachment with intuitive, single-handed release capability in apparel and footwear applications. Referring to the accompanying figures, where like numerals refer to common elements across the various figures, FIGS. 1-8 illustrate a magnetic quick-release closure system 180 that provides enhanced security and operational convenience for athletic activities and general use applications.

### Basic Structure and Components

The magnetic quick-release closure system 180 comprises a closure panel 190 configured to be held in secure contact with a receiving surface 192 through a hybrid combination of magnetic forces and mechanical retention features. This integrated approach provides superior security compared to magnetic-only closures while maintaining significantly easier operation than purely mechanical systems commonly employed in apparel and footwear applications. The closure panel 190 is configured to release from the receiving surface 192 through a deliberate translational movement induced by a user pulling a pull tab 194, enabling reliable single-handed operation during athletic activities. In some embodiments, the closure system may be a component of a personal protective device or athletic padding, such as a shin guard 150

### Closure Panel Configuration

As illustrated in FIG. 1, the closure panel 190 includes a first edge 196, a second edge 200, and an upper edge 214 extending between the first edge 196 and the second edge 200. The second edge 200 includes a notched portion 218 that serves a critical function in the release mechanism by providing clearance for disengagement of the mechanical retention system. The pull tab 194 is positioned on the upper edge 214 and is configured such that a pulling motion applied to the pull tab 194 operates substantially parallel to both the first edge 196 and the second edge 200, ensuring consistent operational mechanics across different user orientations.

The first edge 196 of the closure panel 190 is configured to nest within an upstanding convex ledge 198 formed on the receiving surface 192. The first edge 196 incorporates a rounded or radiused profile corresponding to the curvature of the convex ledge 198, creating a secure nesting engagement that establishes a defined pivot point during closing and opening operations. The convex ledge 198 typically incorporates a total arc of between approximately 100 degrees and 170 degrees, providing sufficient engagement surface to ensure stable mechanical interaction while permitting smooth pivoting motion during operational sequences.

### Receiving Surface Structure

The receiving surface 192 is configured to receive the closure panel 190 and incorporates multiple functional features that contribute to the system's hybrid retention mechanism. The receiving surface 192 includes the upstanding convex ledge 198 that receives the first edge 196 of the closure panel 190, establishing the primary mechanical engagement interface. The receiving surface 192 further incorporates mounting locations for the magnetic components and mechanical retention elements described below.

### Magnetic Attraction System

The magnetic quick-release closure system 180 incorporates a plurality of magnet pairs 206, with a first magnet of each pair being positioned within the closure panel 190 and a second magnet of each pair being positioned within or on the receiving surface 192. These magnet pairs 206 are strategically positioned to create appropriate attraction forces that guide the closure panel 190 into proper alignment during closing operations and maintain secure positioning during use.

The magnetic components may comprise rare-earth permanent magnets such as neodymium iron boron (NdFeB) or neodymium for applications requiring high retention forces, typically in the range of 15-50 pounds, or ceramic ferrite magnets for applications requiring moderate retention forces, typically in the range of 5-15 pounds. The specific magnet selection depends on the intended application requirements, with athletic footwear and performance apparel generally requiring higher retention forces than casual apparel applications.

### Mechanical Retention System

The receiving surface 192 incorporates a retention latch 202 that is biased to extend from the receiving surface 192 and is configured to engage with the second edge 200 of the closure panel 190 when the closure panel 190 is in a closed position. The retention latch 202 includes a sloped surface 204 configured to retract the retention latch 202 when contacted by the second edge 200 of the closure panel 190 during a closing operation, facilitating smooth engagement while providing secure retention once fully closed.

The retention latch 202 is spring-biased toward an extended position through various mechanisms, including an integral cantilever spring, a compression spring, a leaf spring, or an elastomeric element. In embodiments utilizing an integral cantilever spring, the retention latch 202 may be formed as a unitary structure with the receiving surface 192 from materials such as engineering plastics. Alternative embodiments may employ separate spring elements with bias forces typically ranging from approximately 2-10 pounds, calibrated to provide sufficient retention security for athletic activities while remaining easily overcome during both closing and opening operations.

In applications requiring enhanced security, the system may incorporate a plurality of retention latches positioned to engage with the second edge 200 of the closure panel 190, providing redundant mechanical retention. For instance, a dual-latch configuration may be utilized, providing enhanced security for high-intensity athletic applications by requiring a more specific translational movement for release.

### Operation

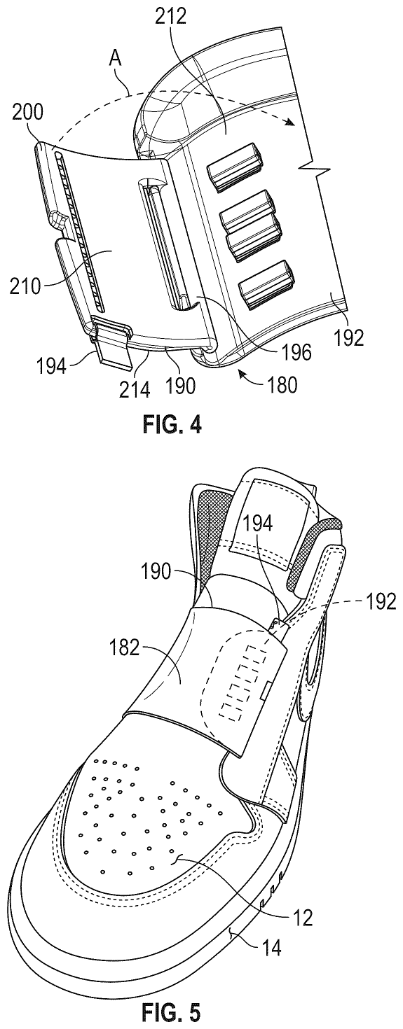

The closing operation sequence begins with the user positioning the first edge 196 of the closure panel 190 into the upstanding convex ledge 198 of the receiving surface 192. Once this nesting engagement is established, the closure panel 190 pivots around the contact point as the second edge 200 traverses an arc A toward the receiving surface 192, as illustrated in FIG. 4. This pivoting motion creates an intuitive closing action that naturally aligns the components through the combination of mechanical guidance and magnetic attraction.

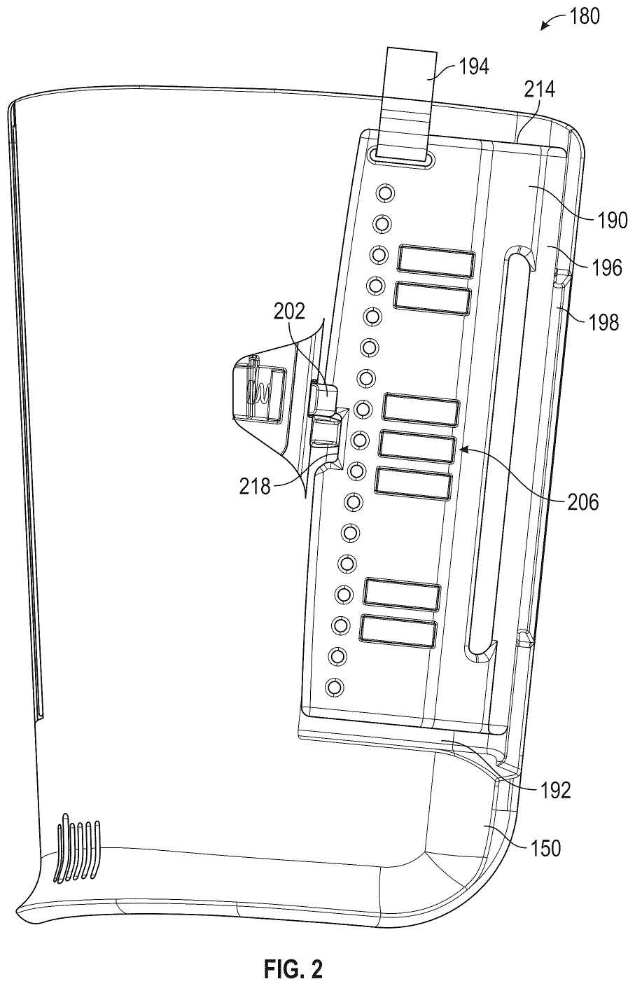

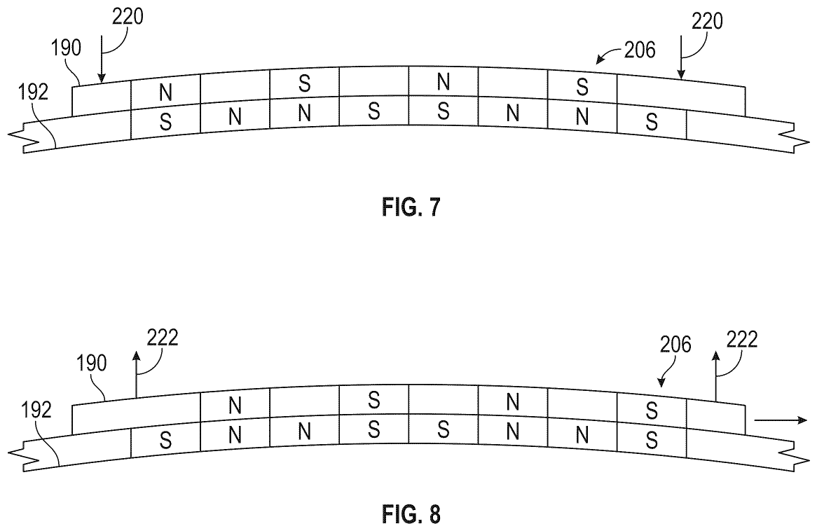

As the closure panel 190 approaches the receiving surface 192, the magnetic attraction 220 (FIG. 7) between the magnet pairs 206 increases, drawing the closure panel 190 toward its fully closed position. During this motion, the second edge 200 contacts the sloped surface 204 of the retention latch 202. Continued user pressure, often assisted by magnetic attraction, causes the retention latch 202 to retract against its spring bias, allowing the second edge 200 to pass beyond the retention latch 202. Once the second edge 200 fully clears the retention latch 202, an inner surface 210 of the closure panel 190 comes into substantially flush contact with an outer surface 212 of the receiving surface 192, as shown in FIG. 2. At this point, the retention latch 202 returns to its extended position due to its spring bias, creating mechanical interference that prevents the closure panel 190 from being pulled away from the receiving surface 192 along its initial pivoting path. This mechanical interference provides security beyond what magnetic attraction alone could offer.

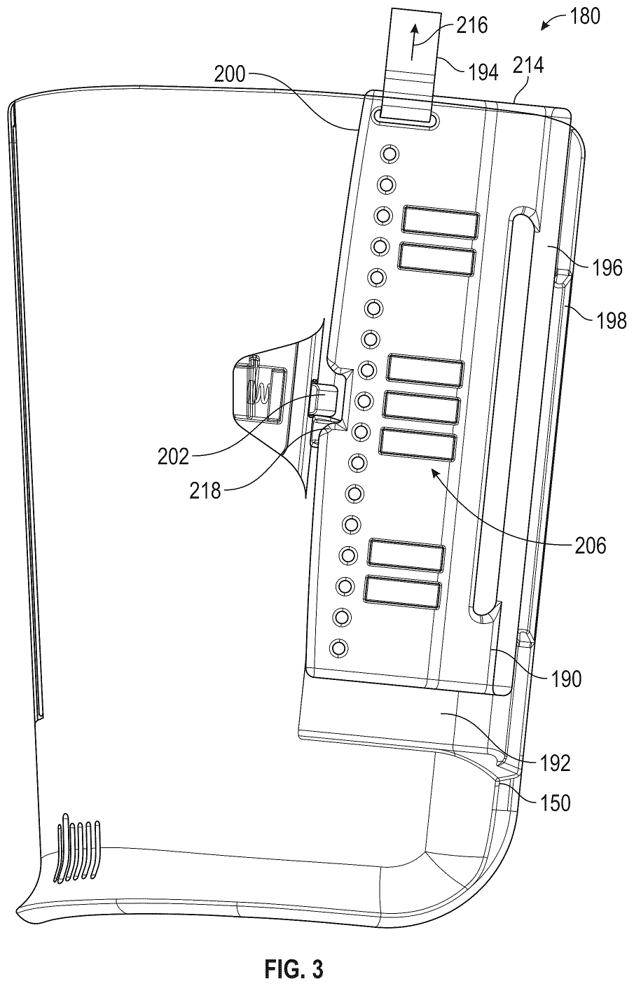

The release operation is initiated by the user pulling the pull tab 194, as illustrated in FIG. 3. The pull force 216 applied through the pull tab 194 induces a translational movement of the closure panel 190 relative to the receiving surface 192. This translational movement is a critical aspect of the release mechanism, as it requires a deliberate action that distinguishes intentional release from incidental contact or loading that might occur during athletic activities.

As the closure panel 190 translates, the notched portion 218 of the second edge 200 moves into alignment with the retention latch 202. When these elements achieve proper alignment (FIG. 3), the retention latch 202 no longer interferes with the movement of the second edge 200, permitting the closure panel 190 to pivot away from the receiving surface 192 and complete the release sequence.

### Magnetic Repulsion Enhancement

In certain embodiments, at least one of the plurality of magnet pairs 206 is positioned such that, during the translational movement induced by the pull tab 194, the magnets in the at least one magnet pair achieve relative positioning to create a repulsive force that assists in separating the closure panel 190 from the receiving surface 192. During normal closed operation, as illustrated in FIG. 7, these specially positioned magnet pairs maintain offset positioning that contributes to the overall attractive force 220 without creating significant repulsive interference. However, when the closure panel 190 translates during the release action, as shown in FIG. 8, these magnet pairs align with opposite poles facing each other, creating a repulsive force 222 that actively assists the separation of the closure panel 190 from the receiving surface 192. This provides additional assistance during the release operation while maintaining secure attraction during normal closed operation.

### Over-Center Locking System

When the magnetic quick-release closure system 180 is employed in conjunction with an elastic band 182, additional security features may be activated. The elastic band 182 may be coupled to the closure panel 190 and configured to encircle a portion of a wearer's body when the closure panel 190 is secured to the receiving surface 192. When the elastic band 182 is attached to the closure panel 190 at a location between the first edge 196 and the second edge 200 (offset from the first edge 196), the system creates an over-center locking action when tension is applied to the elastic band 182. This over-center locking mechanism provides enhanced security during athletic activities by converting applied tension into increased closure retention rather than separation force. As tension increases on the elastic band 182 (e.g., tensions ranging from approximately 10-50 pounds during dynamic activities), the force vector presses the closure panel 190 more firmly against the receiving surface 192, thereby increasing the security of the magnetic and mechanical retention systems. (Illustration of such an elastic band 182 is intentionally omitted from FIGS. 1-3 for illustrative clarity, but such a band may be used).

### Application-Specific Implementations

In footwear applications (FIG. 5), the magnetic quick-release closure system 180 is integrated with an article of footwear comprising a sole structure 14 and an upper 12 secured to the sole structure. The receiving surface 192 is integrated into a portion of the article of footwear, typically in a heel region, midfoot region, an ankle collar, or a tongue, depending on functional requirements. The footwear implementation may include an adjustment element coupled to the closure panel 190, wherein the system 180 selectively secures the adjustment element (e.g., a support structure, fit adjustment component, a traction element, or a performance enhancement feature) in a functional position. An elastic band 182 coupled to the closure panel 190 enables the over-center locking action.

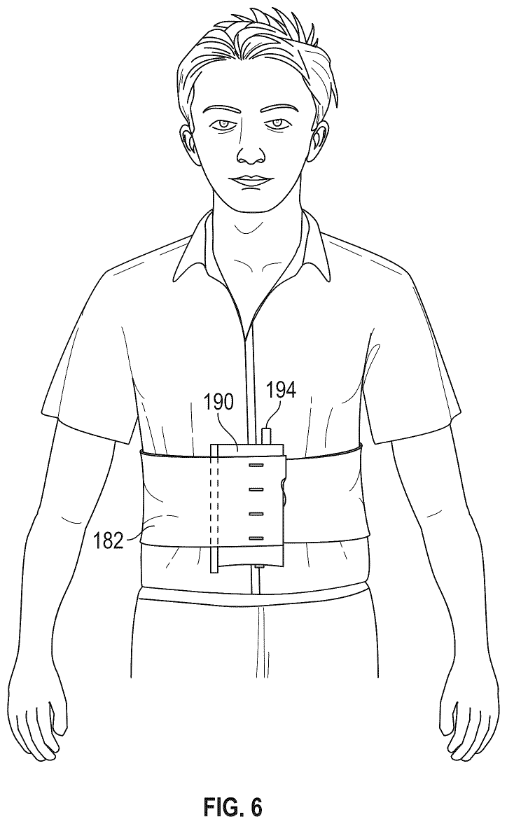

In apparel applications (FIG. 6), the system 180 is integrated with an article of apparel comprising a primary garment structure. The receiving surface 192 is integrated with the primary garment structure, and the system may include a functional component coupled to the closure panel 190. This component may be a detachable hood, a protective panel, an adjustable element, a storage component, a thermal regulation element, or a ventilation panel. The primary garment structure may be an athletic garment, outdoor performance apparel, a protective garment, or technical sportswear. The system is configured for single-handed operation during athletic activities, with the translational release preventing inadvertent opening.

In other embodiments, the magnetic quick-release closure may be implemented in modular athletic equipment, allowing components to be securely attached yet easily reconfigured. The system may be scaled with stronger magnets and robust components for increased loads while maintaining quick-release functionality.

### Materials and Construction

The closure panel 190 and receiving surface 192 may be constructed from various materials suitable for apparel and footwear applications, selected for durability, weight, and environmental resistance. For lightweight applications, these components may be molded from engineering plastics such as polycarbonate, ABS, or nylon. For demanding applications requiring enhanced durability, components may be fabricated from aluminum alloys, composite materials, or high-performance polymers. Typical wall thicknesses for molded components may range from approximately 0.1 mm to 2.0 mm, depending on the specific material and load requirements. The retention latch 202 is typically constructed from materials capable of withstanding repeated flexing cycles without fatigue failure, such as acetal (Delrin), nylon, or spring steel. Material selection should also consider potential degradation from UV exposure, moisture, and common chemicals, especially for outdoor or athletic applications.

Magnet pairs 206 may comprise NdFeB for high-performance or ceramic ferrite magnets for moderate-duty applications. Magnet dimensions typically range from approximately 5-25 millimeters in diameter with thicknesses of approximately 2-10 millimeters.

The magnetic quick-release closure system 180 may be scaled according to specific application requirements while maintaining fundamental operational principles. The system is designed to operate effectively across a range of environmental conditions, for example, within typical ambient temperature ranges from approximately −20° C. to +60° C., without significant degradation in performance. Aesthetic features such as color matching, textural elements, or material inlays may be incorporated to complement the visual design of the associated apparel or footwear.

For applications requiring environmental protection, the interface between the closure panel 190 and receiving surface 192 may incorporate sealing elements such as gaskets, O-rings, or labyrinth seals to create weather-resistant or waterproof seals when the closure is engaged. Multiple sealing methods may be employed depending on the level of protection required. The pull tab 194 may be designed for ergonomic operation, even with gloved hands.

The magnetic quick-release closure system 180 described herein provides significant advancement by combining magnetic attraction for alignment, mechanical retention for security, and an intuitive translational release mechanism enabling reliable single-handed operation while preventing inadvertent opening under normal use conditions.

Additional disclosure of features and alternate/additional uses for the magnetic quick-release closure system are described in U.S. patent application Ser. No. 19/219,653, filed 27 May 2025, entitled Motorized Ambulatory Assist Device, the entire disclosure of which is incorporated by reference in its entirety and for everything that it discloses.

1. A magnetic quick-release closure system comprising:
a closure panel having a first edge, a second edge, and an upper edge extending between the first edge and the second edge, wherein the second edge includes a notched portion;
a receiving surface configured to receive the closure panel;
a plurality of magnet pairs, wherein a first magnet of each pair is located in the closure panel and a second magnet of each pair is located in the receiving surface, the magnet pairs configured to draw the closure panel toward the receiving surface;
a retention latch biased to extend from the receiving surface and configured to engage with the second edge of the closure panel when the closure panel is in a closed position; and
a pull tab coupled to the closure panel and configured, when pulled, to induce a translational movement of the closure panel relative to the receiving surface to align the notched portion of the second edge with the retention latch, thereby allowing the closure panel to be released from the receiving surface.

2. The magnetic quick-release closure system of claim 1, wherein the receiving surface comprises an upstanding convex ledge configured to receive the first edge of the closure panel, the convex ledge providing a pivot point for the closure panel during closing and opening operations.

3. The magnetic quick-release closure system of claim 2, wherein the convex ledge has a total arc of between about 100 degrees and about 170 degrees.

4. The magnetic quick-release closure system of claim 1, wherein the retention latch comprises a sloped surface configured to retract the retention latch when contacted by the second edge of the closure panel during a closing operation.

5. The magnetic quick-release closure system of claim 1, wherein the retention latch is spring-biased toward an extended position by at least one of an integral cantilever spring, a compression spring, a leaf spring, or an elastomeric element.

6. The magnetic quick-release closure system of claim 1, wherein at least one of the plurality of magnet pairs is positioned such that, during the translational movement induced by the pull tab, the magnets in the at least one magnet pair achieve relative positioning to create a repulsive force that assists in separating the closure panel from the receiving surface.

7. The magnetic quick-release closure system of claim 1, further comprising an elastic band coupled to the closure panel and configured to encircle a portion of a wearer's body when the closure panel is secured to the receiving surface.

8. The magnetic quick-release closure system of claim 7, wherein the elastic band is attached to the closure panel at a location between the first edge and the second edge, creating an over-center locking action when tension is applied to the elastic band that increases closure security during dynamic movement.

9. The magnetic quick-release closure system of claim 1, wherein the pull tab is located on the upper edge and configured such that a pulling motion applied to the pull tab is substantially parallel to both the first edge and the second edge.

10. The magnetic quick-release closure system of claim 1, further comprising a plurality of retention latches positioned to engage with the second edge of the closure panel, providing redundant mechanical retention.

11. An article of footwear comprising:
a sole structure;
an upper secured to the sole structure; and
a magnetic quick-release closure system integrated with the article of footwear, the magnetic quick-release closure system comprising:
a receiving surface integrated with a portion of the article of footwear;
a closure panel having a first edge configured to nest with the receiving surface, a second edge including a notched portion, and an upper edge extending between the first edge and the second edge;
a plurality of magnet pairs positioned to draw the closure panel toward the receiving surface;
a retention latch biased to extend from the receiving surface and configured to engage with the second edge of the closure panel when the closure panel is in a closed position; and
a pull tab coupled to the closure panel and configured to induce a translational movement of the closure panel to align the notched portion with the retention latch, thereby disengaging the retention latch and allowing release of the closure panel.

12. The article of footwear of claim 11, further comprising an adjustment element coupled to the closure panel, wherein the magnetic quick-release closure system is configured to selectively secure the adjustment element in a functional position relative to the article of footwear.

13. The article of footwear of claim 12, wherein the adjustment element comprises at least one of a support structure, a fit adjustment component, a traction element, or a performance enhancement feature.

14. The article of footwear of claim 11, wherein the receiving surface is integrated into at least one of a heel region, a midfoot region, an ankle collar, or a tongue of the article of footwear.

15. The article of footwear of claim 11, further comprising an elastic band coupled to the closure panel, wherein engagement of the magnetic quick-release closure system with the elastic band under tension creates an over-center locking action that increases closure security during athletic activities.

16. An article of apparel comprising:
a primary garment structure; and
a magnetic quick-release closure system integrated with the article of apparel, the magnetic quick-release closure system comprising:
a receiving surface integrated with the primary garment structure;
a closure panel having a first edge configured to nest with the receiving surface, a second edge including a notched portion, and an upper edge extending between the first edge and the second edge;
a plurality of magnet pairs positioned to draw the closure panel toward the receiving surface;
a retention latch biased to extend from the receiving surface and configured to engage with the second edge of the closure panel when the closure panel is in a closed position; and
a pull tab located on the upper edge of the closure panel and configured to induce a translational movement of the closure panel to align the notched portion with the retention latch, thereby disengaging the retention latch and allowing release of the closure panel.

17. The article of apparel of claim 16, further comprising a functional component coupled to the closure panel, wherein the magnetic quick-release closure system is configured to selectively secure the functional component to the primary garment structure.

18. The article of apparel of claim 17, wherein the functional component comprises at least one of a detachable hood, a protective panel, an adjustable element, a storage component, a thermal regulation element, or a ventilation panel.

19. The article of apparel of claim 16, wherein the primary garment structure comprises at least one of an athletic garment, outdoor performance apparel, a protective garment, or technical sportswear.

20. The article of apparel of claim 16, wherein the magnetic quick-release closure system is configured to be operated with a single hand while the wearer is engaged in athletic activities, and wherein the translational movement required for release prevents inadvertent opening during such activities.
